(19) United States
(12) Patent Application Publication
(10) Pub. No.: US 2015/0105157 A1
(43) Pub. Date: Apr. 16, 2015

(54) GAME CONTROLLER LUMBAR SUPPORT BOARD

(71) Applicant: William Brent Meldeau, Chatsworth, CA (US)

(72) Inventor: William Brent Meldeau, Chatsworth, CA (US)

(21) Appl. No.: 14/513,999

(22) Filed: Oct. 14, 2014

Related U.S. Application Data
(60) Provisional application No. 61/891,645, filed on Oct. 16, 2013.

(51) Int. Cl. A63F 13/245; A63F 13/816

(52) U.S. Cl. CPC A63F 13/245; A63F 13/816
USPC 463/36

(57) ABSTRACT

An active game controller includes a plurality of load sensors for detecting a load applied on an exercise support apparatus having a seat support area attached thereto a lumbar support portion that supports the lumbar region of a person's body on which a player performs abdominal sit-ups, push-ups, poses or stretches upon. The active game controller wirelessly transmits a load value detected as manipulation data by the load sensors to a game machine or smart device. The game machine or smart device determines a necessary quantity of load values, and the game machine or smart device computes the necessary quantity of load values based on the detected load value from the active game controller. Subsequently, game processing is performed based on the necessary quantity of computed load values received from both the seat support area and lumbar support portion.

### BACKGROUND OF THE INVENTION

1. Field of the Invention

The present invention relates to an active game controller, a storage medium storing a game program, a game machine or smart device, and particularly to the active game controller including a plurality of load sensors, the storage medium storing a game program for performing game processing with the active game controller, and the game machine or smart device.

2. Description of the Related Art

U.S. Pat. No. 8,740,705 to Yamazaki et al discloses a game controller used in a game machine, comprising: a support portion on which player's legs are ridden; at least four load sensors disposed at predetermined intervals below said support portion; and a communication means for transmitting a load value as manipulation data detected from each of said four load sensors to said game machine. The support portion as displayed in this patent is a flat surface which is not capable of supporting the lumbar region of a person's body for game processing.

U.S. Pat. No. 8,512,142 to Meldeau discloses a game controller includes a plurality of load sensors for detecting a load applied on an exercise support board having at least one stepping exercise platform and attached thereto a sliding platform having concave sides on which player's legs are ridden. The game controller transmits a load value detected as manipulation data by the load sensors to a game machine. The support board as displayed in this patent has concave sides on which a player's legs are ridden and is not capable of supporting the lumbar region of a person's body for game processing.

U.S. Pat. No. 6,623,270 to Meldeau discloses an abdominal exercise device has an elongated body with a first seating end having a tailbone pad mounted thereon, adjacent a raised second lumbar support end. The lumbar support end has a multi-curved upper surface, including a concave portion between raised side rails that conforms to the lumbar region of a person's body to allow the person to achieve a better, more comfortable workout, with accelerated and improved results.

Presently, there are no current game controllers that support the lumbar region of a person's body which allows the sensing of abdominal sit-ups, push-ups, poses or stretches for game processing.

### SUMMARY OF THE INVENTION

In view of the foregoing, an object of the present invention is to provide a novel active game controller.

Another object of the present invention is to provide an active game controller that can perform manipulations using load sensors.

Still another object of the present invention is to provide a novel storage medium storing a game program, in which an active game controller that supports the lumbar region of a person's body including a plurality of load sensors is used to sense abdominal exercising, postures, stretches and poses of an individual, and a game machine or smart device.

Still another object of the present invention is to provide a storage medium storing a game program, which can compute a quantity of load values necessary for game processing to perform game processing using an active game controller that includes a seat support area and lumbar support portion including a plurality of load sensors, and a game machine or smart device.

In the present invention, the following configurations are adopted to solve the problems. A parenthetic reference numeral and supplementary explanation indicate correlation with the later-described embodiments for the purpose of the easy understanding of the present invention, and do not restrict the present invention.

In a first aspect of the present invention, an active game controller used in a game machine or smart device includes a seat support area and a lumbar support portion that supports to the lumbar region of a person's body; load sensors are disposed at predetermined intervals below the seat support area and lumbar support portion; and a communication means for transmitting a load value as manipulation data detected from each of the load sensors.

In the first aspect of the present invention, the active game controller 10 consists of an exercise apparatus and is used as the manipulation means or input means of a game machine or smart device (not shown). The active game controller includes a seat support area 12, and lumbar support portion 24 on which the player's buttocks and lumbar is supported, and load sensors 14 are disposed at predetermined intervals below the seat support area and lumbar support portion. The load applied by the players contact on the seat support area and lumbar support portion is detected by the load sensors. Communication means as disclosed in U.S. Pat. No. 8,740,705 transmits the load value as the manipulation data detected from each of the load sensors. Accordingly, in the game machine or smart device, the game can be performed based on the load values detected by the load sensors.

According to the first aspect of the present invention, load sensors are provided on the peripheral corners of the active game controller, and the load value as the manipulation data detected from each of the load sensors is transmitted to the game machine or smart device, so that the active game controller can perform various manipulations using the load applied by the player can be provided.

In another aspect of the present invention, preferably an active game controller according to the first aspect of the present invention further includes a power supply unit that supplies electric power to the load sensor; and a power supply control means for controlling power supply from the power supply unit to the load sensor, wherein the communication means includes a reception determining means for determining whether or not a load obtaining command is received from the game machine or smart device, the power supply control means supplies electric power from the power supply unit to the load sensor when the reception determining means determines that the load obtaining command is received, and the power supply control means stops electric power supply from the power supply unit to the load sensor when the reception determining means determines that the load obtaining command is not received.

Another aspect of the present invention is an active game controller according to the first aspect of the present invention, preferably the communication means includes a wireless communication unit receiving wirelessly the load obtaining command from the game machine or smart device; and a processing means for imparting the load value as the manipulation data detected from each of the load sensors to the wireless communication unit when the wireless communication unit receives the load obtaining command, and the wireless communication unit wirelessly transmits the manipulation data received from the processing means to the game machine or smart device .

In another aspect of the present invention, the wireless active game controller that can wirelessly transmit and receive the data to and from the game machine or smart device can be provided.

According to the present invention, the load of the player is detected by load sensors and the detected load value is set to the manipulation data to perform the game processing, so that the active game controller that can perform various manipulations using the load sensors can be provided.

The necessary quantity is determined and the necessary quantity of load values is computed, so that various quantities of load values can be used in the game processing by various combinations of values of the plural load sensors. Accordingly, a novel game played by the load of the player using the active game controller including the plurality of load sensors can be proposed.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side cross-sectional view showing the active game controller shown in FIG. 2 resting on a flat surface, with a person, shown in broken line, lying in a supine position thereon performing an abdominal sit-up;

FIG. 2 is a perspective view showing an appearance of an active game controller according to an embodiment of the present invention.

FIG. 3 is a bottom view of the active game controller shown in FIG. 2

### DETAILED DESCRIPTION OF THE PREFERRED EMBODIMENTS

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as the basis for the claims and as a basis for teaching one skilled in the art how to make or use the invention.

For the purposes of the present invention, the active game controller lumbar support board device can be used in place of the game controller identified as numeral 10 as displayed in the interactive gaming system as disclosed in U.S. Pat. No. 8,740,705 to Yamazaki et al, which is hereby incorporated by reference in its entirety, and commonly referred to as a “Wii Fit”.

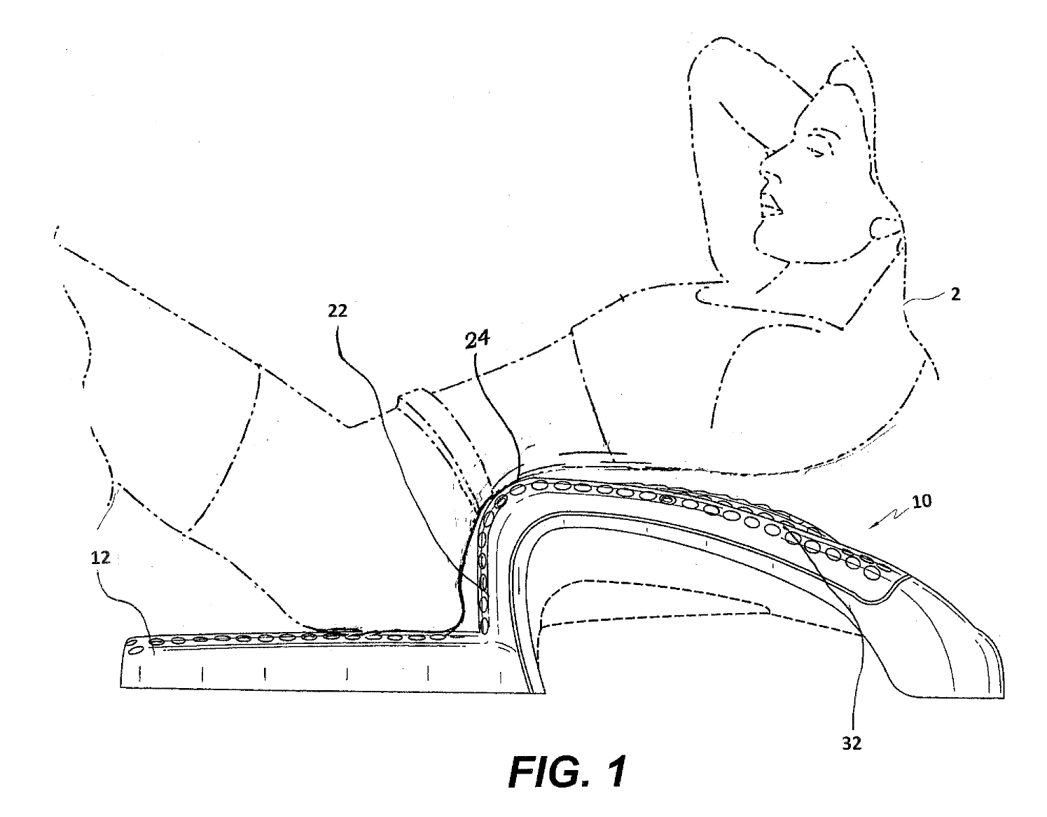

Referring to the drawings of the present invention, FIG. 1 shows a controller with a seat portion area 12 and lumbar support portion 24 which may be used for interactive exercising whereby a user 2 can perform abdominal sit-ups, push-ups, poses or stretches upon the active game controller 10 in conjunction with an interactive gaming system or smart device.

Preferably the seat support area 12 is joined to the front wall 22 of the lumbar support portion 24 which is in turn connected to a downwardly sloping wall 32. Pluralities of load sensors 14 are located in both the seat support area 12 and the lumbar support portion 24 and are installed and utilized in accordance with the structure and procedure as displayed in U.S. Pat. No. 8,740,705 to Yamazaki et al.

In use, when one wishes to exercise with the apparatus of the invention, the active game controller 10 is positioned flatly on the ground allowing a user to perform sit-ups, push-ups, poses or stretches upon the seat support 12, and lumbar support portion 24 thereof when exercising. It will be appreciated that a user may only sit on the seat support portion 12 and lay back on lumbar support portion 24 for physical game play benefits. Thus, the exercise apparatus of the present invention combines the features of a lumbar support device with a seat support, enabling the user to work a multitude of active game exercises upon the present invention.

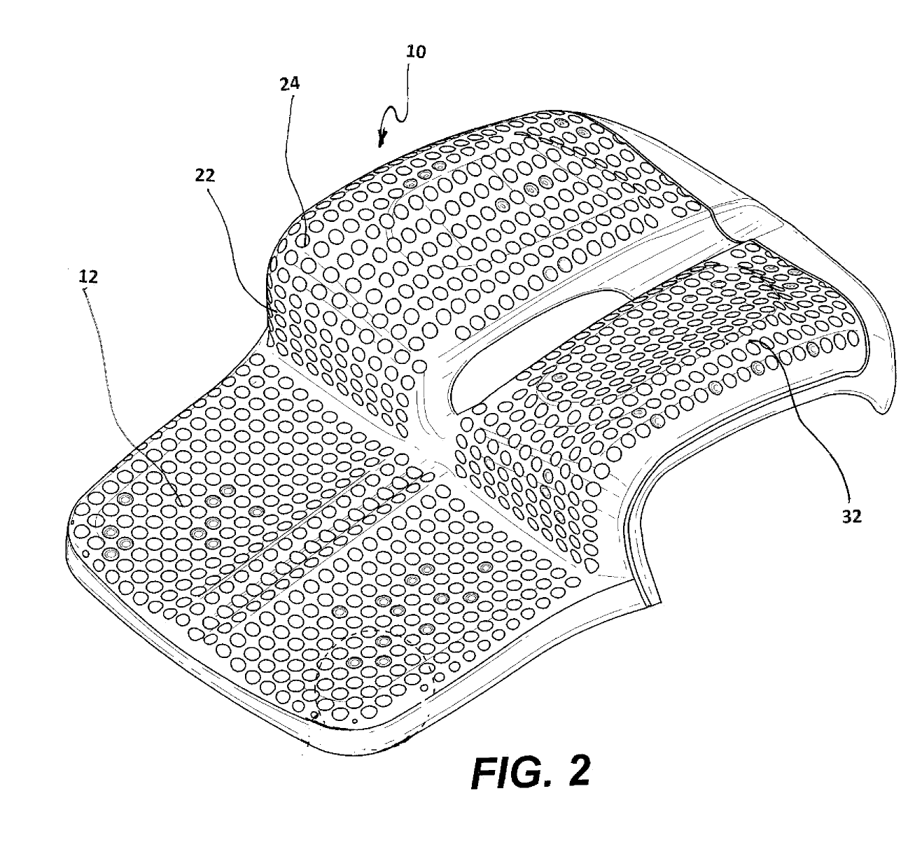

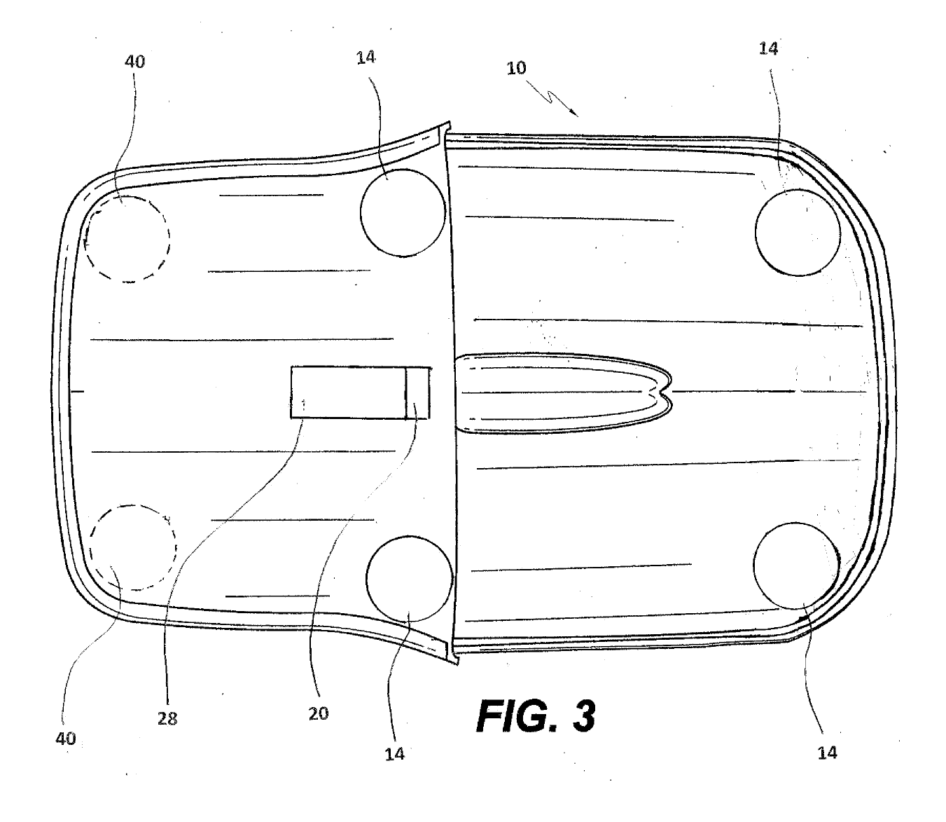

With further reference to FIG. 2, an active game controller 10 according to an embodiment of the present invention is a manipulation device or input device for active gaming. The seat support area 12 and lumbar support portion 24 is an active game controller on which a player performs sit-ups, push-ups, poses or stretches with the active game controller containing load sensors 14 that detect loads applied on the apparatus. The load sensors 14 are accommodated in the active game controller, and a possible arrangement of the load sensors 14 is shown by solid circle line in FIG. 3.

In the seat support area 12, multiple load sensors 14 are arranged at predetermined intervals. In the preferred embodiment, two load sensors 14 are arranged in peripheral portions of the seat support area 12, specifically, at the two designated corners. The interval between the load sensors 14 is set to an appropriate value such that player's intention can accurately be detected for the load applied to the apparatus in game manipulation. Similarly, multiple load sensors 14 are preferably placed in peripheral portions of the lumbar support portion 24.

As displayed in United States Patent U.S. Pat. No. 8,740,705, the load sensors 14 are formed by, e.g., a strain gage (strain sensor) type load cell, and the load sensor 14 is a load transducer that converts the input load into an electric signal. In the load sensor 14, a strain inducing element is deformed to generate a strain according to the input load. The strain is converted into a change in electric resistance by a strain sensor adhering to the strain inducing element, and the change in electric resistance is converted into a change in voltage. Accordingly, the load sensor 14 outputs a voltage signal indicating the input load from an output terminal when the voltage is imparted to the load sensor 14 from a power supply terminal. The load sensor 14 is formed by, e.g., a strain gage (strain sensor) type load cell, and the load sensor 14 is a load transducer that converts the input load into an electric signal. In the load sensor 14, a strain inducing element is deformed to generate a strain according to the input load. The strain is converted into a change in electric resistance by a strain sensor adhering to the strain inducing element, and the change in electric resistance is converted into a change in voltage. Accordingly, the load sensor 14 outputs a voltage signal indicating the input load from an output terminal when the voltage is imparted to the load sensor 14 from a power supply terminal. Other types of load sensors such as a folk vibrating type, a string vibrating type, an electrostatic capacity type, a piezoelectric type, and gyroscope type may be used as the load sensor 14.

As displayed in FIG. 3 showing the bottom surface of the active game controller 10 includes a microcomputer 20 that controls an operation of the active game controller 10. The microcomputer 20 includes a ROM and a RAM (not shown) and a power source 28 and controls the operation of the active game controller 10 according to a program stored in the ROM. The active game controller 10 includes rubber gripping members 40 shown in broken lines in FIG. 3 on the bottom surface thereof to engage a support surface so it will not slip when it is used.

The active game controller 10 may directly be connected to a game machine or smart device using a connector or the active game controller exerciser 10 may wirelessly transmit and receive data to and from the game machine or smart device.

The electric power may be supplied to the load sensor 14 and the transfer of the outputs from each load sensor 14 indicating the input load, in accordance with the any of the techniques and system design displayed in U.S. Pat. No. 8,740,705.

In each of the above-described embodiments, the load sensors 14 are arranged in the peripheral portion of the seat support area 12 or in the peripheral corners of the lumbar support portion 24. However, the load sensors 14 can be arranged at any predetermined intervals so as to ensure the accuracy of load detection.

While the preferred embodiments have been shown and described, it will be understood that there is no intent to limit the invention by such disclosure, but rather, is intended to cover all modifications and alternate constructions falling within the spirit and scope of the invention.

1. A active game controller used in a game machine or smart device , comprising both a seat support area and lumbar support portion formed with a front wall angling upwards and joining a top curved portion which is in turn connected to a downwardly sloping wall on which a player performs abdominal sit-ups, push-ups, poses or stretches upon; a plurality of load sensors disposed at predetermined spaced intervals below said active game controller for sensing said exercises; and a communication means for transmitting a load value as manipulation data detected from each of said load sensors to said game machine or smart device as the player exercises upon each spaced load sensor.

2. The active game controller according to claim 1, further comprising:
a power supply unit that supplies electric power to said load sensors; and
a power supply control means for controlling power supply from said power supply unit to said load sensor, wherein said communication means includes a reception determining means for determining whether or not a load obtaining command is received from said game machine or smart device , said power supply control means supplies electric power from said power supply unit to said load sensor when said reception determining means determines that said load obtaining command is received, and said power supply control means stops electric power supply from said power supply unit to said load sensor when said reception determining means determines that said load obtaining command is not received.

3. The active game controller according to claim 1, wherein said communication means includes;
a wireless communication unit receiving wirelessly said load obtaining command from said game machine or smart device ; and a processing means for imparting the load value as the manipulation data detected from each of said load sensors to said wireless communication unit when said wireless communication unit receives said load obtaining command, and said wireless communication unit wirelessly transmits said manipulation data received from said processing means to said game machine or smart device .

4. The active game controller according to claim 1, wherein said communication means includes a connector unit detachable from a different type of active game controller, and said communication means transmits said load value to said game machine or smart device through said different type of active game controller attached to said connector unit.

5. The active game controller according to claim 1, wherein said communication means includes:
a command determining means for determining which load obtaining command in a plurality of types of load obtaining commands is received from said game machine or smart device; and a manipulation data computing means for computing a predetermined quantity of pieces of manipulation data according to the load obtaining command determined by said command determining means from the load value detected from each of said load sensors.

6. The active game controller according to claim 1, further comprising:
a manipulation button provided in a surface different from an upper surface of said support portions to be manipulated by the player's body.

7. The active game controller according to claim 1, wherein said seat support area and lumbar support portion comprises an exercise platform having a base for placement on a support surface.

8. A active game controller used in a game machine or smart device , comprising a seat support area and lumbar support portion that allows the player to perform sit-ups, push-ups, poses or stretches upon; a plurality of load sensors disposed at predetermined intervals below said seat support area and lumbar support portion for sensing player's sit-ups, push-ups, stretches or poses upon each spaced load sensor; and a communication means for transmitting a load value as manipulation data detected from each of said load sensors to said game machine or smart device as the player performs sit-ups, push-ups, poses or stretches upon each spaced load sensor.
